(19) United States
(12) Patent Application Publication
(10) Pub. No.: US 2009/0265550 A1
(43) Pub. Date: Oct. 22, 2009

(54) Method and arrangement for transmitting data in a communication system that employs a multi-hop method

(76) Inventors: Michael Bahr, Munchen (DE); Michael Finkenzeller, Munchen (DE); Matthias Kutschenreuter, Munchen (DE); Sebastian Bacnk, Diessenhofen (CH); Christian Schwingenschlogl, Putzbrunn (DE); Norbert Vicari, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/991,214

(22) PCT Filed: Aug. 16, 2006
(86) PCT No.: PCT/EP2006/065351

§ 371 Date: Feb. 28, 2008

(30) Foreign Application Priority Data
Aug. 29, 2005 (DE) 10 2005 040 889.3

(51) Int. Cl. H04L 9/28; H04L 12/56

(52) U.S. Cl. 713/168; 380/44; 370/400

(57) ABSTRACT

In a multi-hop network, packets are classified into header and user data for coded distribution. The header information, especially the multi-hop information, is separated in a coded manner from the user data, such that each network node need only decode the header in order to forward the packet. The header and the user data are guided, independently from each other, to the hardware of the respective device for separate coding, as if they were complete packets. A hardware accelerated coding of header and user data is possible using different keys. The header also contains integrity protection.

### CROSS REFERENCE TO RELATED APPLICATIONS

This application is the US National Stage of International Application No. PCT/EP2006/065351, filed Aug. 16, 2006 and claims the benefit thereof. The International Application claims the benefits of German application No. 10 2005 040 889.3 DE filed Aug. 29, 2005, both of the applications are incorporated by reference herein in their entirety.

### FIELD OF INVENTION

The invention relates to a method for transmitting data in a communication system that employs a multi-hop method. The invention relates further to an arrangement for implementing the method.

### BACKGROUND OF INVENTION

In radio communication systems, messages containing, for instance, voice, image, video, SMS (Short Message Service), or MMS (Multimedia Messaging Service) information, or other data, are transmitted between the transmitting and receiving radio station with the aid of electromagnetic waves via a radio interface. Depending on how the radio communication system is specifically embodied, the radio stations, which in network terminology are referred to also as nodes, can therein be various types of user radio stations or network-side radio stations such as radio access points or base stations. In a mobile radio communication system, at least a part of the user radio stations are mobile radio stations. The electromagnetic waves are radiated at carrier frequencies in the frequency band provided for the respective system.

Mobile radio communication systems are frequently embodied as cellular systems conforming to, for instance, the GSM (Global System for Mobile communication) or UMTS (Universal Mobile Telecommunications System) standard having a network infrastructure consisting of, for example, base stations, devices for checking and controlling the base stations, and other network-side devices.

Apart from said cellular, hierarchical radio networks organized to provide wide area (supralocal) coverage there are also wireless local area networks (WLANs) providing as a rule spatially far more limited radio coverage. Being, for instance, a few hundred meters in diameter, the cells covered by the WLANs' radio access points (APs) are small in comparison with customary mobile radio cells. HiperLAN, DECT, IEEE 802.11, Bluetooth, and WATM are examples of different standards for WLANs.

The non-licensed frequency range around 2.4 GHz is often used for WLANs. Although not yet uniformly regulated internationally, there also exists a frequency band in the 5-GHz range that is often used for WLANs. Data transmission rates of over 50 Mbit/s can be achieved using conventional WLANs; with future WLAN standards (IEEE 802.11n, for example) it will be possible to achieve data transmission rates of over 100 Mbit/s. Data rates substantially above those offered by third-generation mobile radio, UMTS for example, will therefore be available to WLAN users. So access to WLANs for connections with a fast bit rate is of interest for transmitting large volumes of data, in particular in connection with accessing the internet.

A connection can also be established over the WLAN radio access points to other communication systems, for example the internet. For this purpose the WLAN's radio stations communicate either directly with a radio access point or, when radio stations are further apart, via other radio stations that will forward the information between the radio station and radio access point over a path between the radio station and radio access point. In communication systems of said type, referred to as multi-hop communication systems, data is transmitted from a transmitting station to an ultimately receiving station either directly or via a multiplicity of interposed intermediate or relay stations. Apart from over a single interposed relay station, the data can also be transmitted over a multiplicity of relay stations connected one behind the other in series, also referred to as multi-hopping.

For non-multi-hop WLAN systems it is known how to employ security mechanisms whose purpose is to prevent eavesdropping on the data being transmitted. For example IEEE802.11i provides in that regard for the use of different keys for each logical connection, as can be seen from FIG. 1. However, that approach has the disadvantage of being optimized for one hop only, not for a multi-hop system.

There are variants designed to eliminate that disadvantage. For example there is an approach that employs what is termed a “pre-shared key” (PSK). A key is therein formed that is valid throughout the network and used for authenticating and for key agreement. That, though, is associated with a reduction in the level of security.

### SUMMARY OF INVENTION

So what is being discussed for future standards is using a different key for each connection. That, though, will encumber the system since the encrypting and decrypting required at each node will delay data transmission and so impede the very applications, like Voice-over-IP, that require real time.

An object of the invention is to disclose an accelerated method for securely communicating by radio in a multi-hop system.

Said object is achieved by means of a method having the features of an independent claim and by an arrangement having the features of a further independent claim.

With the inventive method for transmitting data in a communication system that employs a multi-hop method and has at least one network consisting of at least one node, the data from a transmitting first node to a second node receiving the data is in each case received and forwarded by at least one third node located between the first and second node. The data is therein fragmented into packets for transmitting. The packets have a payload data component and at least one first control data component assigned to the multi-hop method as well as a second control data component assigned to the network. Data is encrypted based on at least one first master key determined by the first node and second node. The payload data component and at least the first control data component are therein encrypted separately.

The inventive method advantageously accelerates encrypting for end-to-end encryption of the payload data because the payload data component and control data component can thanks to their separate encrypting be encrypted by hardware means. Encrypting by hardware means is generally performed many times faster than by software means. Delays that would be caused by encrypting and decrypting are significantly reduced thereby.

According to the method, the payload data component and first control data component are preferably treated like complete packets for encrypting purposes. That means they are routed to the hardware for encrypting as though they were in each case a complete packet. The advantageous result is that the hardware present in current devices can be used for separately encrypting the control data components and payload data component.

The payload data component is preferably encrypted based on the first master key (PMK). The payload data will as a result be encrypted advantageously end-to-end. That means the payload data will be remain encrypted and hence protected until arriving at the destination node.

If a second master key determined by the respective transmitting first node and by a neighboring node suitable as a third node is formed and preferably the first control data components are encrypted based on the second master key, then the information assigned to the multi-hop method and as a rule containing the path provided for the packets will likewise not be able to be evaluated, which will further significantly enhance the system's security. Because the key is furthermore based on a master key which results from the transmitting node and neighboring node, the neighboring node will also be able to decipher and evaluate the control data component and, where applicable, initiate forwarding to a next neighboring node in accordance with the information contained therein.

A further improvement in encryption and hence in security will be achieved if a second key is determined derived from the first master key and a first key is determined derived from the second master key, if the packets for transmission in the respective first node are each encrypted in such a way that the first control data component will be encrypted using the first key, the payload data component will be encrypted using the second key, the second control data component will remain unencrypted, and the packets are thereafter transmitted to the third node, and if the third node decrypts the first control data component encrypted using the first key and evaluates the control data component, with the payload data then being encrypted using the second key and the transmission terminated if the third node corresponds to the second node and, if the third node does not correspond to the second node, the third node being set as the first node and the steps being repeated starting with deriving a first key—the second key does not need to be regenerated because, of course, according to the invention the payload data needs only to be encrypted end-to-end, which is to say from source node to sink. The improvement in security is therein due to being able to take further encoding measures while keys are being derived, for example generating the second key using a random generator so that non-repeating keys will as a rule be formed for each further transmission, that can make it more difficult or impossible for an attacker or eavesdropper to decrypt the data.

It is alternatively also possible to generate an integrity value for the first and/or second control data component using the first key. Said value is added to the packet, for example after the control data components. A third node will then not have to decrypt the control data components because they were not encrypted. The third node instead performs an integrity check on the control data components for which an integrity value has been generated. There will as a result advantageously be integrity protection for the first and/or second control data component during each transmission between nodes.

If packets generated in accordance with the multi-hop method and containing only routing messages are additionally completely encrypted, then the data exchanged as a rule for negotiating a path in advance of actual payload data transmission will also not be susceptible to evaluation by an attacker so that attacks cannot focus on the intermediate nodes to be used for the transmission. A further security stage is hence established thereby that furthermore will likewise cause no delay in payload data transmission.

The routing packets are therein preferably generated in accordance with a routing protocol so that standardized communication between the nodes or networks will be insured.

The routing message packets can therein be generated within the second layer 2 of the OSI reference model or within the third layer of the OSI reference model as these are particularly suitable for implementing the inventive method.

An AODV protocol, OLSR protocol, or derivatives thereof will preferably function as protocols especially for generating within the third layer.

A security model widely used in present-day networks will be provided as a basis if encrypting is performed in accordance with security methods conforming to IEEE802.1X so that implementing will be simplified and acceptance of the inventive method enhanced. That will apply in particular if at least one of the networks operates in conformity with IEEE802.11 or its derivatives.

The second control data component will then preferably be formed by header data according to IEEE802.11 and the first control data component by header data according to the multi-hop method since that corresponds to the customary procedure and a thus embodied communication system and the networks contained therein will hence be able to perform the inventive method with little adjustment.

An efficient method for encrypting data will result if encrypting takes place using a 128-bit key in conformity with the “CCMP” Counter Mode CBC-MAC Protocol.

The inventive arrangement for transmitting data using a multi-hop method is characterized by means for implementing the method as claimed in one of the preceding claims.

### BRIEF DESCRIPTION OF THE DRAWINGS

Further advantages and specifics of the invention are explained in more detail with the aid of the description relating to FIGS. 1 to 4, in which:

FIG. 1: shows an encryption agreement in a single-hop system conforming to IEEE802.1X,

FIG. 2: shows the structure of a payload data packet in an inventive communication system,

FIG. 3: is a schematic of a key hierarchy of the kind on which the exemplary embodiment of the invention is based,

FIG. 4: is a simplified schematic showing how an integrity value is generated according to AES/CCMP, and

FIG. 5: is a schematic of the packet processing flow and of the structure of a resulting packet.

### DETAILED DESCRIPTION OF INVENTION

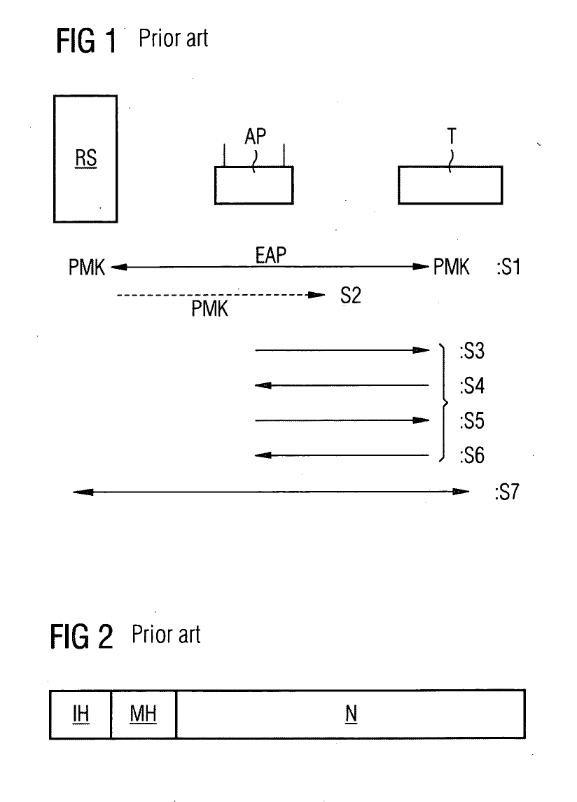

FIG. 1 is a schematic of an encryption agreement, known from the prior art, conforming to IEEE802.11i in a network standardized according to IEEE802.1X.

It can be seen therein that it is a system restricted to single hops, because the hop is reduced to one intermediate station, namely the access point AP shown provided between a user terminal T and what is termed a radius server RS for bridging purposes or establishing a wireless data transmission between the radius server RS and user terminal T.

It can further be seen that authenticating serving to agree a shared key, referred to as a “Pairwise Master Key” (PMK)—or master key for short—takes place at a first step S1 via the network shown embodied according to IEE802.1X using what is termed the “Extensible Authentication Protocol” EAP.

The agreed master key PMK is then at a second step S2 notified to the access point AP so that said AP can then, at ensuing steps S3 to S6 in what is termed a handshake message exchange, generate a key for the communication between the terminal T and access point AP necessary for a transmission session.

for this purpose a random sequence is generated in the access point AP at the third step S3 and conveyed to the terminal T, which at the fourth step S4 likewise generates a random sequence and, using the random sequence of the access point AP, conveys it in encrypted form to the access point AP so that a key designated a group key and valid for the connection between the access point AP and terminal T can, in conjunction with the master key, be generated in the access point AP at the fifth step S5 and notified to the terminal T encrypted with its random sequence and the terminal T and access point AP will both have the information enabling what is termed a “Pairwise Transient Key” (PTK) to be generated that will be valid for the duration of the session.

Successful completion of said generating is finally acknowledged at the sixth step S6 by means of a confirmation message encrypted with the PTK and directed at the access point AP.

Data transmission, safeguarded by encryption, between the radius server RS and terminal T can then take place at a seventh step S7.

For transmission according to an inventive exemplary embodiment based on a network embodied in accordance with IEEE802.11 the data is therein divided into packets, like one shown in FIG. 2, consisting of a payload data component N and at least one first control data component MH necessary for handling the multi-hop method as well as a second control data component IH formed in accordance with IEEE802.11.

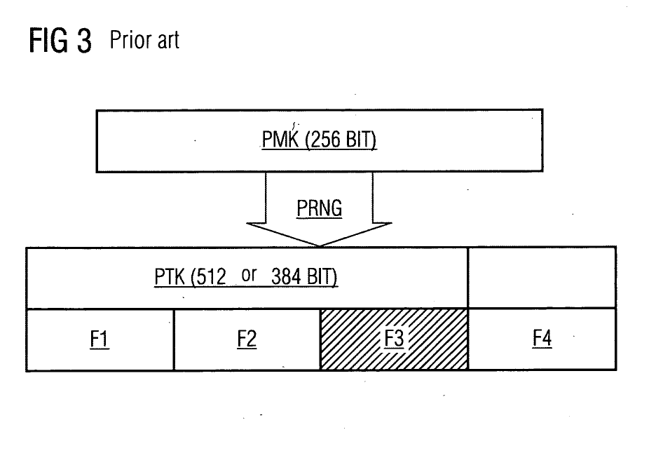

FIG. 3 further shows schematically on which security hierarchy the inventive exemplary embodiment is based. Data is encrypted as shown proceeding from a first level E1 characterized by a master key (Pairwise Master Key—PMK) from which, by means of a random number generation (Pseudo Random Number Generator—PNRG) performed at the second level E2, a group key (Pairwise Transient Key—PTK) is generated, which according to TKIP can be 512 bits in length or according to AES-CCMP can be 384 bits in length, of which, as can be seen at the fourth level E4, in each case a part is used for encrypting certain types of data, for example 128 bits for EAPol Encryption F1, 128 bits for EAPol MIC F2, and 128 bits for Data Encryption F3.

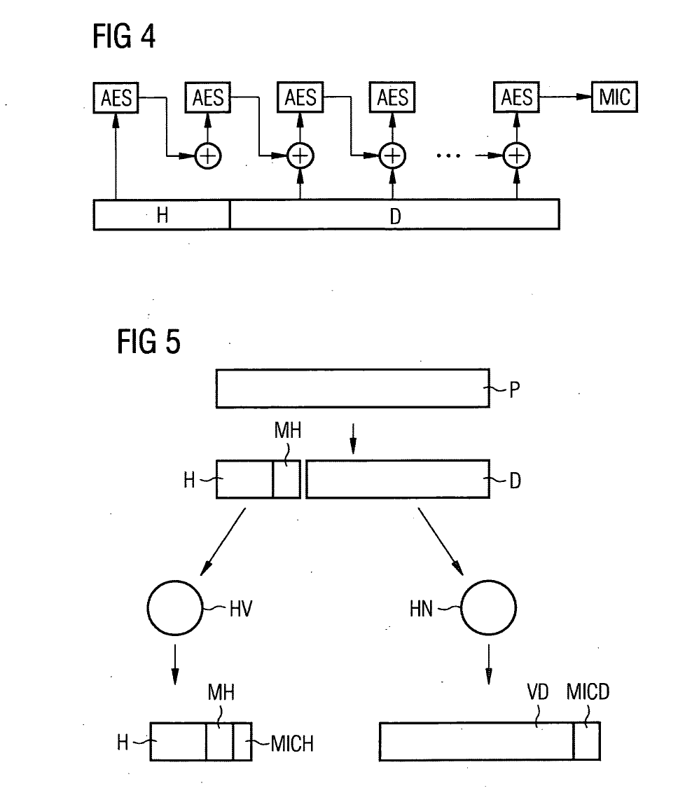

FIG. 4 is a schematic showing how an integrity value MIC is generated as known from the prior art by means of AES/CCMP.

A packet consisting of a header H and a payload data component D is therein processed in 128-bit blocks. The result of processing the individual blocks AES is therein in each case dependent on the respectively preceding block AES.

Finally, FIG. 5 is a flowchart ensuing from the inventive method based on the above-cited system and also shows the structure of a data packet resulting therefrom.

A packet P is therein divided into the header and data D. The header consists of the network header H and multi-hop header MH.

The header is thereafter transferred to the hardware for generating a first integrity value MICH. Said value is generated using a first key. The header is therein treated as though it were a complete packet, thereby making hardware-supported fast encryption possible. The first key is therein a PTK, meaning a pairwise transient key between a respective transmitting node and its neighbor.

The data is furthermore transferred analogously to the hardware for encryption using a second key. The second key is therein a key that is determined for the transmission between the respective transmitting device and ultimately receiving device. A second integrity value MICD belonging to the encrypted data can also be generated in the case of this encryption.

The result is a structure of the data packet from the unencrypted header H and multi-hop header MH as well as from the first integrity value MICH and the encrypted data VD and a second integrity value MICD belonging to the encrypted data.

It is alternatively possible to encrypt the multi-hop header MH using the first key. The integrity value then generated is valid only for the multi-hop header MH and can be added to the packet just like the first integrity value MICH. The header H will then remain unencrypted.

1.-18. (canceled)

19. A method for transmitting data in a communication system using a multi-hop method, comprising:
providing a network, wherein the network has a node;
providing a first node transmitting data;
providing a second node receiving data;
providing a third node for receiving data and forwarding data;
transmitting data from the first node to the second node via the third node;
fragmenting data into packets for transmission purposes, wherein the packets have
a payload data component,
a first control data component assigned to the multi-hop method, and
a second control data component assigned to the network; and
encrypting the data based upon at least a first master key determined by the first node and second node, wherein the payload data component and the first control data component are encrypted separately.

20. The method as claimed in claim 19, wherein the payload data component and the first control data component are encrypted like complete packets.

21. The method as claimed in claim 19, wherein only the payload data component is encrypted based on the first master key.

22. The method as claimed in claim 19, wherein a second master key determined by the respective transmitting first node and by a neighboring node suitable as a third node is formed.

23. The method as claimed in claim 19, wherein a second master key is determined based upon the first node and the neighboring third node.

24. The method as claimed in claim 22, wherein the first control data component is encrypted based upon the second master key.

25. The method as claimed in claim 19, wherein:
a second key derived from the first master key is determined,
a first key derived from the second master key is determined,
the packets for transmission in the respective first node are each encrypted in such a way that
the first control data component is encrypted using the first key,
the payload data component is encrypted using the second key, and
the second control data component remains unencrypted,
the packets are transmitted to the third node,
the third node decrypts the first control data component or first and second control data component encrypted using the first key, and
the third node evaluates the control data component, wherein
the payload data is encrypted using the second key and the transmission is terminated if the third node corresponds to the second node, and
if the third node does not correspond to the second node
the third node is set as the first node, and
the packets are transmitted again to the third node, and
the third node decrypts again the first control data component or first and second control data component encrypted using the first key, and
the third node evaluates again the control data component.

26. The method as claimed in claim 19, wherein:
a second key derived from the first master key is determined,
a first key derived from the second master key is determined,
the packets for transmission in the respective first node are each encrypted in such a way that
an integrity value is generated for the first and/or second control data component using the first key and added to the packet,
the payload data component is encrypted using the second key, and
the second control data component remains unencrypted,
the packets are transmitted to the third node,
using the first key the third node performs an integrity check on the control data components for which an integrity value has been generated, and
the third node evaluates the control data component, wherein
the payload data is encrypted using the second key and the transmission is terminated if the third node corresponds to the second node, and
if the third node does not correspond to the second node the third node is set as the first node.

27. The method as claimed in claim 19, wherein packets generated in accordance with the multi-hop method and containing only routing messages are completely encrypted.

28. The method as claimed in claim 27, wherein routing packets are generated in accordance with a routing protocol.

29. The method as claimed in claim 28, wherein the routing message packets are generated within a second layer of a OSI reference model.

30. The method as claimed in claim 27, wherein the routing message packets are generated within a third layer of a OSI reference model.

31. The method as claimed in claim 27, wherein an AODV protocol, an OLSR protocol, or derivatives thereof function as protocols.

32. The method as claimed in claim 19, wherein the encryption is performed in accordance with security methods conforming to IEEE802.1X and/or IEEE802.11i.

33. The method as claimed in claim 19, wherein at least one of a plurality of networks operates in conformity with IEEE802.11 or its derivatives.

34. The method as claimed in claim 19, wherein the second control data component is formed by header data according to IEEE802.11.

35. The method as claimed in claim 19, wherein the first control data component is formed by header data according to the multi-hop method.

36. The method as claimed in claim 19, wherein the encryption is based upon a 128-bit key in conformity with a Counter Mode CBC-MAC Protocol.
